(19) United States
(12) Patent Application Publication
(10) Pub. No.: US 2015/0102102 A1
(43) Pub. Date: Apr. 16, 2015

(54) SYSTEM FOR INVENTORY TRACKING AND MONITORING USING A DATABASE OF LOW-POWER ACTIVE TAGS AND A METHOD FOR ITS USE

(71) Applicant: HealthVentive, LLC, Santa Monica, CA (US)

(72) Inventors: Thomas Heim, Los Angeles, CA (US); Steven Eric Schlanger, Flagstaff, AZ (US)

(21) Appl. No.: 14/079,815

(22) Filed: Nov. 14, 2013

Related U.S. Application Data
(60) Provisional application No. 61/889,051, filed on Oct. 10, 2013.

(51) Int. Cl. G06K 7/10; G07C 9/00; G06Q 10/08

(52) U.S. Cl. CPC G06K 7/10366; G06Q 10/087; G07C 9/00103
USPC 235/382; 235/385

(57) ABSTRACT

Described herein is a device and system for very low power wireless communication between small transceivers, which are applied to objects and remote databases or programs. The disclosed device and system requires so little energy that ordinary inexpensive coin cells can power a transceiver for many years. The system disclosed herein gives the benefits of true bi-directional interactive communication but at a very low cost and power requirement. The ability of the transceiver to respond using its own power source represents a fundamental advance in the state of the art over traditional RFID methods.

### RELATED APPLICATION DATA

This application claims the benefit of Provisional Application No. 61/889,051, filed on Oct. 10, 2013.

### TECHNICAL FIELD

Embodiments disclosed herein relate generally to systems for organizing inventory, and in particular to the organization of inventory using radio frequency identification technology.

### BACKGROUND ART

There is substantial interest in and numerous applications for the ability to allow collections of information, hereinafter referred to as “Databases”, to interact with and communicate with small inexpensive devices to signal conditions or alerts to people. Such small devices with the features of signaling, storage, and wireless communication are hereinafter referred to as “tags”. Little doubt exists that the geometric connectivity of devices, such as tags, available via the Internet will be the next frontier of enormous growth, subject to the ability to manage security, privacy, power and cost.

However, the tags currently available do not present an ideal combination of cost, power, and flexibility. Passive tags, which rely on an interrogating device to induce currents in their circuitry, can only act in reaction to interrogation, and thus lack the ability to initiate communication or engage in complex processing. The range of such tags is also inherently very limited. Active tags, which have their own power source, can do what passive tags cannot, but quickly consume power, and thus battery life.

Thus, there remains a need for a system that uses very little power while achieving the full potential of systems of such tags to track and store data.

### SUMMARY OF THE EMBODIMENTS

A system is disclosed for inventory monitoring and tracking, including at least one tag having a very low duty cycle, a low duty cycle, a transceiver, a memory and a microprocessor configured to switch between the very low duty cycle and the low duty cycle, to transmit and receive signals via the transceiver, to read data from the memory, and to write data to the memory, and at least one hub having a radio frequency communication device configured to communicate with the at least one tag.

In a related embodiment of the system, the at least one tag is configured to communicate on a first radio frequency when operating in the very low duty cycle, and on a second, distinct radio frequency while operating in the low duty cycle. Another embodiment includes a database accessible to the at least one hub. An additional embodiment includes a signaling facility coupled to the at least one tag. In another embodiment, the system includes at least one sensor coupled to the at least one tag. The at least one sensor further includes a touch plate in one embodiment. The at least one sensor also includes a heat sensor in another. In another embodiment still, the at least one sensor includes a motion sensor. Another embodiment of the system includes at least one computing device, transmitting data to the at least one hub and receiving data from the at least one hub.

A method for inventory monitoring is also disclosed. The method involves listening, by a first tag as provided in claim 1, for a command, during a first active phase of a first duty cycle, determining, by the first tag, that no command is present, and ceasing activity for a rest phase of the first duty cycle, listening, by the first tag, during a second active phase of the first duty cycle, receiving, by the first tag, via the transceiver, at least one command, and executing, by the first tag, the at least one command.

In a related embodiment, receiving the at least one command further involves receiving the at least one command from a hub. Receiving the at least one command additionally involves receiving the at least one command from a second tag, in another embodiment. In still another embodiment, executing the at least one command involves transmitting data using the transceiver. In a related embodiment, transmitting further involves transmitting, to at least one additional tag, a command. Another method also involves producing, by the at least one additional tag, a signal using a signal-emitting facility coupled to the at least one additional tag. An additional method involves providing, by a hub, the transmitted data to a user. A related method includes storing, by the hub, the transmitted data in memory accessible to the hub. Yet another related method includes receiving, by the hub, a query from a computing device, matching, by the hub, the query to the transmitted data, and providing, by the hub, to the computing device, the transmitted data.

In another embodiment, executing the at least one command further involves modifying the memory of the first tag. Executing the at least one command further includes signaling, by a signal-emitting facility coupled to the first tag, a state of the first tag, according to another embodiment. In an additional embodiment, executing the at least one command also includes switching to a second duty cycle. In still another embodiment, executing the at least one command further comprises switching radio frequencies. Another embodiment involves receiving an additional command from at least one sensor coupled to the tag, and executing the additional command. Executing the command involves maintaining, in the memory of the first tag, the at least one command, comparing, by the first tag, the additional command to the at least one command, and executing, by the first tag, the at least one command based on the comparison with the additional command, in still another embodiment.

Also disclosed is a method for authentication, including receiving, by a tag, from a hub, a passphrase, and authenticating, by the tag, the passphrase.

In a related embodiment, receiving the passphrase further involves receiving an encrypted passphrase and decrypting the encrypted passphrase. An additional embodiment involves receiving, from a hub, a command. A related embodiment involves receiving, from a peer tag, a command. Still another embodiment includes receiving, from a second hub, a second passphrase and authenticating, by the tag, the second passphrase. In a related embodiment, receiving the second passphrase also includes receiving a encrypted second passphrase and decrypting the encrypted second passphrase.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1 is a schematic diagram depicting a computing device;

FIG. 2A is a schematic diagram depicting one embodiment of the disclosed system;

FIG. 2B is a schematic diagram depicting one embodiment of a tag;

FIG. 2C is a schematic diagram showing one embodiment of a tag;

FIG. 2D is a schematic diagram of an embodiment of a driving circuit for a tag;

FIG. 2E is a schematic diagram of an embodiment of a hub;

FIG. 3 is a schematic diagram of an embodiment of the disclosed system;

FIG. 4A is a flowchart illustrating one embodiment of a process for communication using a tag;

FIG. 4B is a schematic diagram illustrating an exemplary use of the disclosed system;

FIG. 4C is a schematic diagram illustrating an exemplary use of the disclosed system;

FIG. 5A is a flowchart illustrating one embodiment of a process for authentication;

FIG. 5B is a schematic diagram portraying an embodiment of an authentication process; and

FIG. 5C is a schematic diagram illustrating an exemplary use of the disclosed system.

### DETAILED DESCRIPTION OF SPECIFIC EMBODIMENTS

Embodiments of the disclosed system and method provide a low-cost, flexible, and secure way to track inventory. The tags have the ability to communicate with each other and to and from the hub using a power saving method, which allows for very long life with small coin cells. People can be signaled by a tag for purposes of finding the object that the tag is attached to or signaling an action or a reminder for a person. The tags can store information about the object or person and such information can be retrieved from a database and stored in the tag for the benefit of the user or changes in information can be generated in the tag and stored in the Database for actions by others.

Definitions. As used in this description and the accompanying claims, the following terms shall have the meanings indicated, unless the context otherwise requires.

A “computing device” is defined as including personal computers, laptops, tablets, smart phones, and any other computing device capable of supporting an application as described herein, and as set forth more fully below.

A first electronic device is “coupled” to a second electronic device if it is so related to the second electronic device that the first device and the second device may be operated together as one machine. In particular, a piece of electronic equipment is coupled to a an electronic device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry devices” is a general term for all equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components.

A computing device's “optical data entry devices” are components coupled to the computing device that record images on an electronic image sensor, for instance using a digital camera, video camera, or scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other computing devices have existed for decades, and are known to persons of ordinary skill in this system and method's technical field. Furthermore, persons of ordinary skill in the art will be aware of cameras that can be attached to computers to transfer video that they have captured, digital video cameras that operate while attached to computers (i.e. “webcams”), and the digital cameras capable of capturing video that are built into many mobile phones.

A computing device's “digital scanning devices” as used herein is a general term for all equipment coupled to a computing device that may be used to capture and record in digital form data stored in an object not coupled to the computing device. Digital scanning devices includes, without limitation, laser scanners or digital cameras for reading bar codes, optical scanners or digital cameras for reading QR codes or printed text, RFID readers, NFC readers, magnetic readers, and any other electrical component capable of capturing a pattern in solid shapes, variations in electromagnetic forces or radiation, variations in heat or pressure, or the output of any method for signal storage or propagation.

A computing device's “audio data entry devices” are devices that capture sound waves and vibrations and convert them into a digital signal that may be stored and played by a computing device. Audio data entries include, without limitation, microphones.

A computing device's “display” is a device coupled to the computing device, by means of which the computing device can display images. Displays include without limitation monitors, screens, television devices, and projectors, as well as liquid crystal display (“LCD”) devices and arrays of light-emitting diodes.

To “maintain” data in the memory of a computing device means to store that data in that memory in a form convenient for retrieval as required by the algorithm at issue, and to retrieve, update, or delete the data as needed.

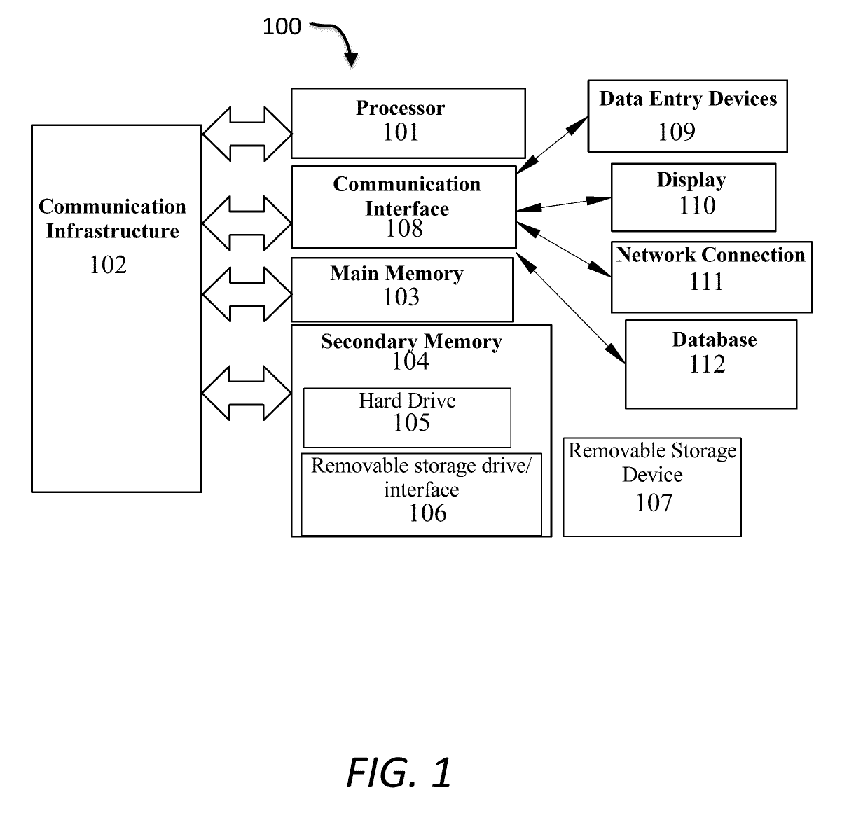

Some embodiments of the disclosed system and methods will be better understood by reference to the following comments concerning computing devices. The system and method disclosed herein will be better understood in light of the following observations concerning the computing devices that support the disclosed application, and concerning the nature of web applications in general. An exemplary computing device is illustrated by FIG. 1. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. The communications interface in the system embodiments discussed herein facilitates the coupling of the computing device with data entry devices 109, the device's display 110, and network connections, whether wired or wireless 111. It should be noted that each of these means may be embedded in the device itself, attached via a port, or tethered using a wireless technology such as BLUETOOTH®.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any device must necessarily comprise facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

Embodiments of the disclosed method and system provide users with a robust, flexible, and cost-effective way to track inventory. The tags placed on inventory can store data concerning the inventory's optimal state, and compare it to data concerning its current state as provided by sensors and radio frequency communication. Hubs query tags and relay the resulting information to computing devices via networks, enabling an end user virtually anywhere to interrogate the set of all tags at any time, transforming the set of tags into a database. Tags conserve power through management of low and very low duty cycles, and use peer-to-peer communication to route around outages, enhance security, and aid users in locating inventory that requires attention.

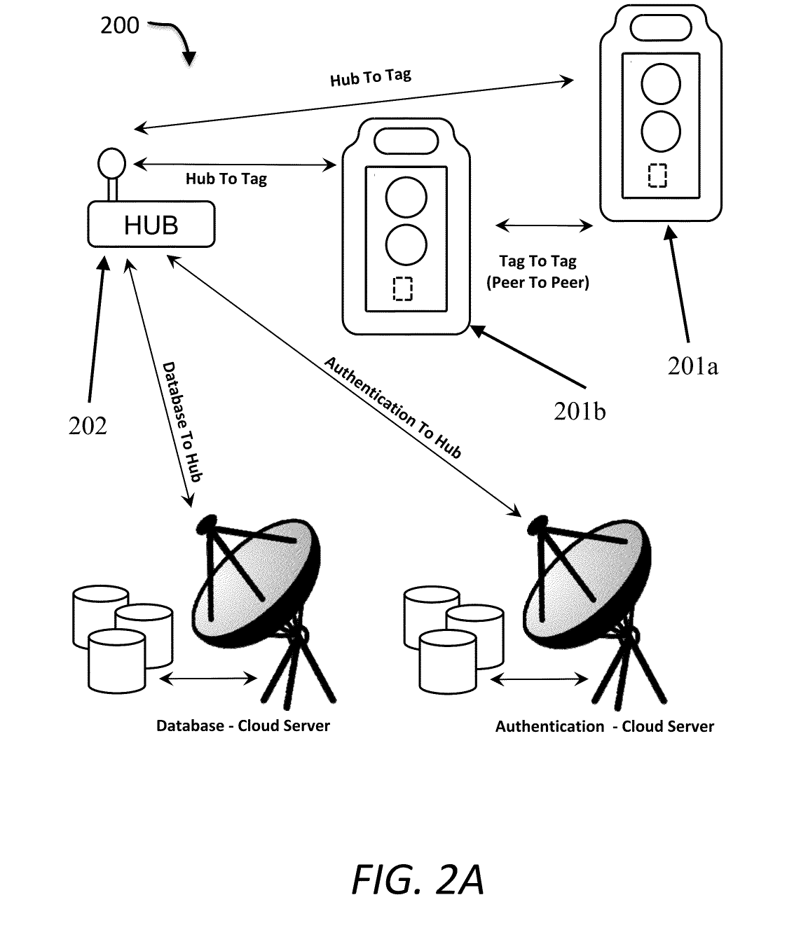

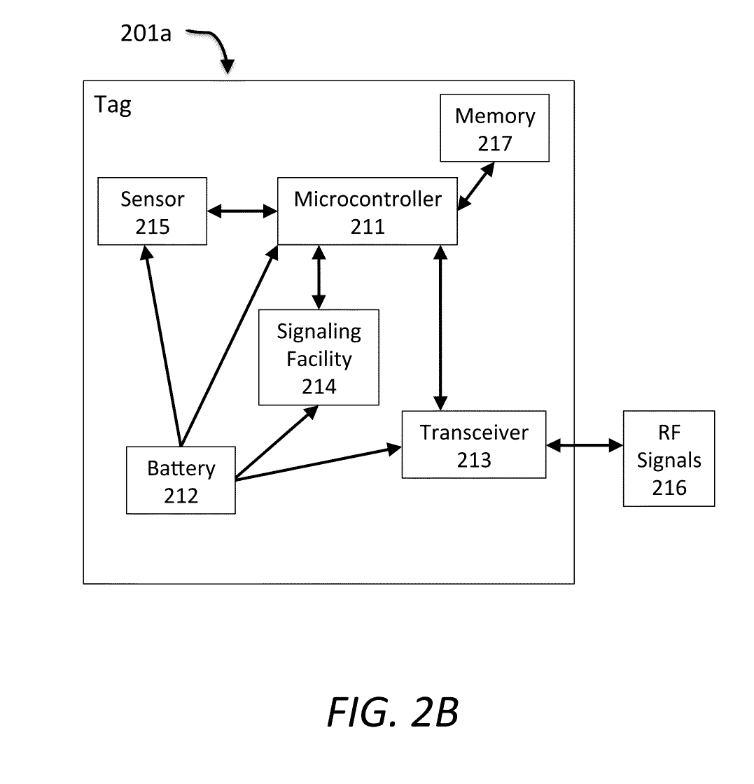

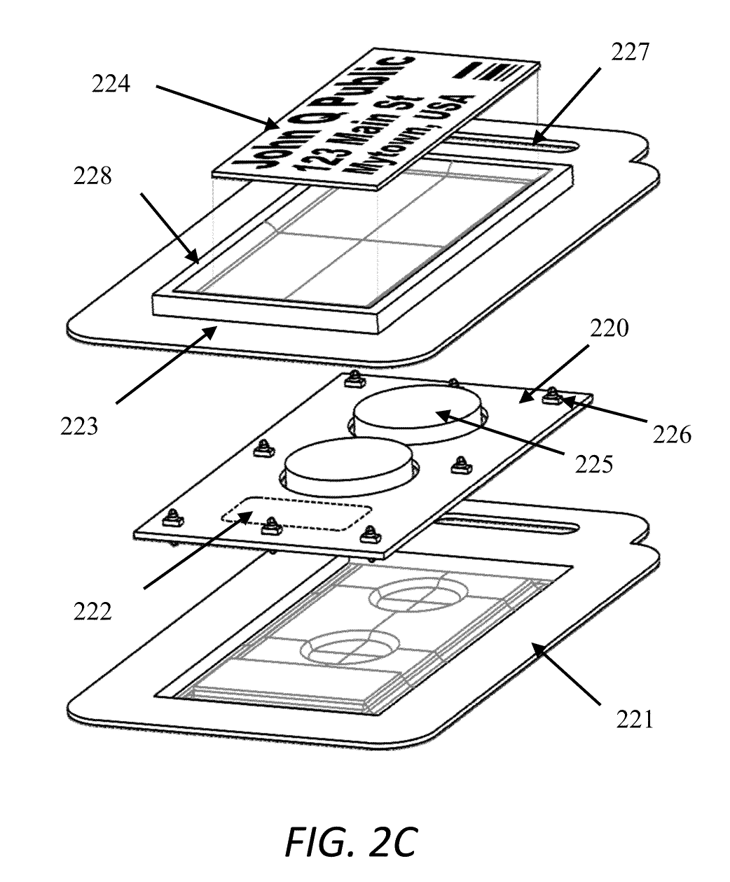

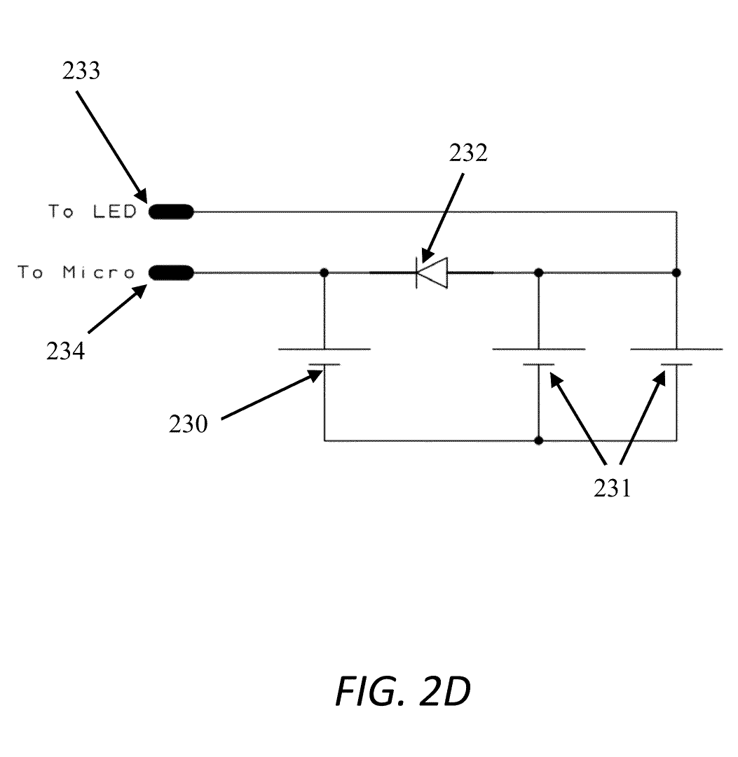

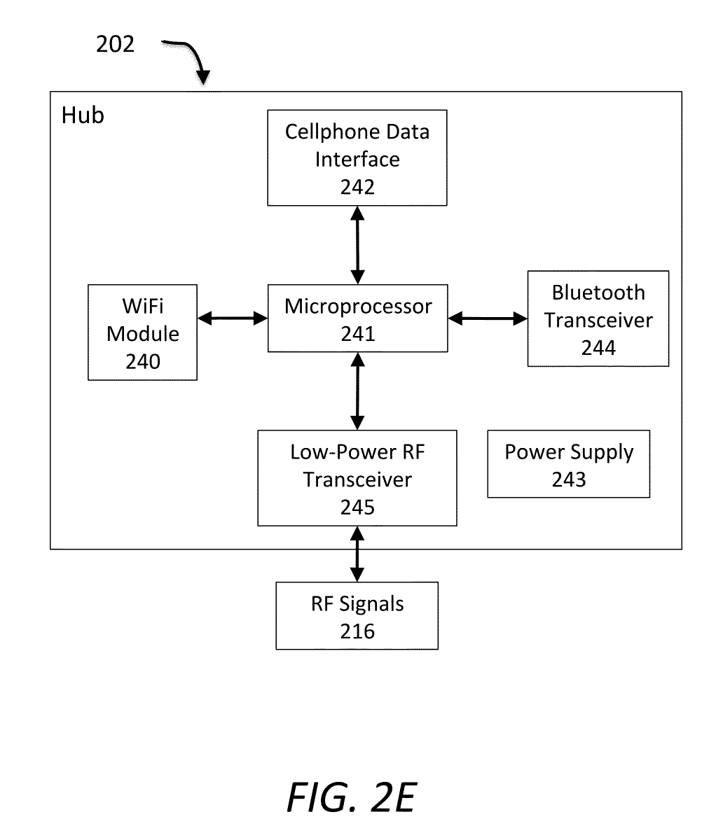

FIG. 2A illustrates one embodiment of the disclosed system 200. The system 200 includes at least one tag 201a having a very low duty cycle, a low duty cycle, a radio frequency communication device, a memory, and a microcontroller configured to switch between the very low duty cycle and the low duty cycle, to transmit and receive signals via the radio frequency communication device, to read data from the memory, and to write data to the memory, and at least one hub 202 having a radio frequency communication device configured to communicate with the at least one tag.

The system includes at least one tag 201a. FIG. 2B is a schematic diagram illustrating one embodiment of the at least one tag 201a. Some embodiments of the at least one tag 201a use a microcontroller 211. The microcontroller 211 may be a processor as set forth above in reference to FIG. 1. The microcontroller 211 may be powered by a small battery 212, typically a coin cell of very small size and weight. The at least one tag device includes a radio frequency communication device. The at least one tag 201a may use a low-power wireless transceiver 213, which is polled at a low duty cycle by the microcontroller 211 to save power. The rate at which the microcontroller 211 polls the wireless transceiver 213 may vary. In particular, the microcontroller 211 may poll the wireless transceiver 213 according to a low duty cycle or according to a very low duty cycle, as defined below. The at least one tag 201a periodically wakes up, sniffs for radio traffic, and if none is found it then goes back to sleep. When a valid alert command or condition is detected, the microcontroller 211 acts upon the receipt of the command or conditions. The microcontroller 211 may execute a received command. The at least one tag 201a has a memory 217 coupled to the microprocessor 211. The memory may be a memory 103, 104 as disclosed above in reference to FIG. 1.

Some embodiments of the system 200 include a signaling facility 214 coupled to the at least one tag 201a. The signaling facility 214 may be any device capable of signaling to a person near the at least one tag concerning the at least one tag condition. In some embodiments, the signaling facility 214 is a device that emits light. The signaling facility 214 may be an incandescent bulb. The signaling facility 214 may be a fluorescent bulb. The signaling facility 214 may be a light emitting diode (“LED”). The signaling facility 214 may be an array of one or more LEDs that may be flashed in a readily discernable pattern so that the owner can visually identify the flashing tag. The flashing LED or LEDs may be of a type with very high brightness, which is easily visible from a distance. The pattern of the flashes and the color may be programmed so that, for example, in the case of a luggage tag, one piece of luggage may be quickly and easily discerned from another. The signaling facility 214 may be an audio device. The signaling facility 214 might be a vibrator.

In some embodiments, the system includes at least one sensor 215 coupled to the at least one tag 201a. The at least one tag 201a may be fitted with a touch sensor, such as a touch plate or switch, so that for instance when pressed or touched, any one of the tags can send an alert to all in the group or back to the Hub. The at least one sensor 215 may also be a heat sensor. The at least one sensor may also be a motion sensor. The at least one sensor may be a light sensor.

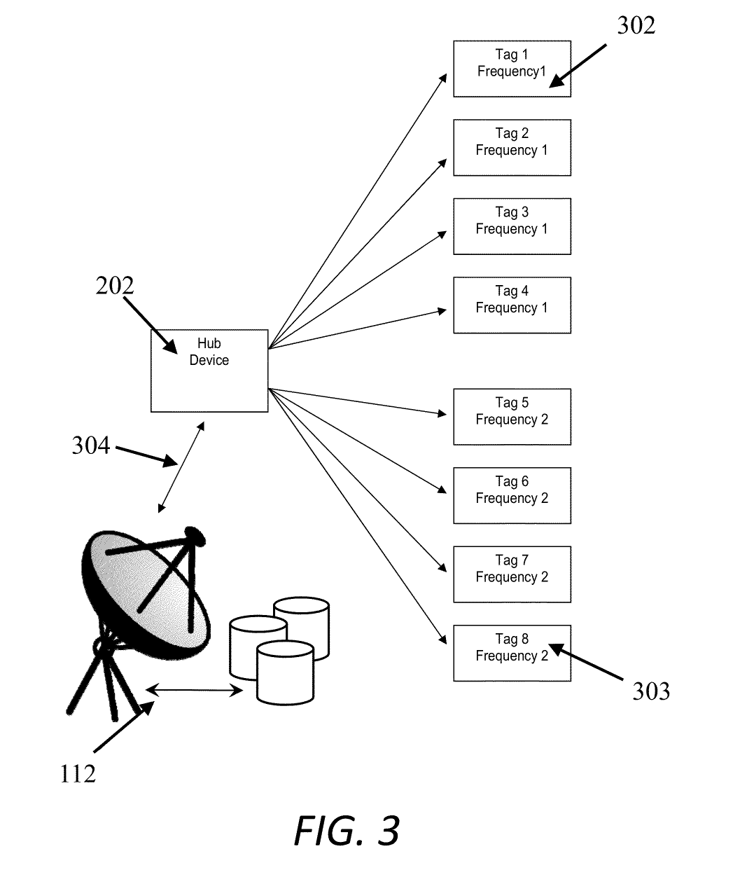

In some embodiments, the at least one tag 201a has both a low duty cycle and a very low duty cycle, and the microprocessor 211 is configured to switch between the two duty cycles. FIG. 3 describes the polled operation of the transceiver 213. The at least one tag 201a is asleep for a fixed amount of time, referred to herein as a “rest phase,” for example 300 milliseconds. At the end of this time the microcontroller 211 wakes up for its “active phase,” during which the microcontroller 211 checks for radio traffic. If at the end of a second fixed amount of time, for example 10 milliseconds, the microcontroller 211 senses no radio traffic it is programmed to receive, the microcontroller 211 causes the at least one tag to enter the next rest phase. If there is radio traffic, and the microcontroller 211 identifies the radio traffic as relevant to the at least one tag 201a in question, then a command (for example flash the LEDs) is executed; when the command finishes executing, if there is no further relevant radio traffic, the at least one tag 201a goes back to sleep. In the exemplary case just described for a low duty cycle, the average power consumption by the at least one tag 201a will be 10/300 (3.3%) of the average power consumption compared to when the at least one tag 201a is awake.

The at least one tag in some embodiments also has a very low duty cycle. In some embodiments, the very low duty cycle is one with an active phase/rest phase ratio at least a power of ten smaller than that of the low duty cycle; for instance, the active phase may be 10 milliseconds while the rest phase is 7 seconds. This represents a duty cycle of 10/7000=0.14%, which is sufficiently low to power the at least one tag 201a for many years. Such a low duty cycle requires, however, a response time (up to 7 seconds), which is long in human terms. The at least one tag 201a is thus designed in some embodiments to switch from the very low duty cycle to the low duty cycle when practical, as set forth in more detail below. Likewise, in some embodiments the at least one tag 201a is configured to switch from the low duty cycle to the very low duty cycle when the latter is more practical. In some embodiments, the at least one tag 201a is configured to communicate on a first radio frequency when operating in the very low duty cycle, and on a second, distinct radio frequency while operating in a low duty cycle. For instance, since faster, higher duty cycle radio traffic may be able to wake up very low duty cycle tags the system 200 may have the ability to change the radio frequency of slower, and lower power tags to segregate those which are not immediately needed for use. In some embodiments, the tags have a third duty cycle that is smaller still, for longer-term storage. For example, in the case of a system designed to retrieve bags of prescriptions in a pharmacy, those bags which are unclaimed after 30 days could have a longer than 7 second response time because the likelihood of needing to signal those items in less than 7 seconds is low.

A solution to prevent noise and to provide a smooth uninterrupted power supply to the microcontroller 211 in some embodiments of the at least one tag 201a is shown in FIG. 2D. The battery configuration shown here is optimally suited to provide a large amount of current to an LED when the battery output current is limited. FIG. 2D discloses a battery 230, which is used only to support the microcontroller 211 or any other non-LED loads from circuitry in the at least one tag. In some embodiments, the battery used for the load other than the LED constitutes a power supply bus 234 which is isolated from the power supply used for the LEDs 214 the use of a switching diode 232. When the LEDs are turned on, meaning current is drawn from power supply 233, then the switching diode 232 is reverse-biased and one or more batteries 231 supply current to the LEDs and the battery dedicated to supporting the microcontroller 230 does not. When the LEDs 214 are not in use then both batteries, 230 and 231 share the quiescent load provided that the micro battery is sufficiently discharged for the diode 232 to become forward biased at a low current level. In an alternate example of this system, a plurality of batteries is used for high current loads, such as LEDs 214, since the battery 230 isolated by the switching diode 232 is only required to support the quiescent load of the microcontroller.

FIG. 2C shows one possible embodiment of packaging for a tag 201a, which minimizes the perceived thickness of the device while maximizing the light output. The packaging format presents the device as a thin rugged emulation of a passive luggage tag. The tag 201a in some embodiments assembles all of its circuitry on a printed circuit board (“PCB”) assembly 220. LED lights 228 may be mounted close to the edge of the PCB to maximize the perceived size of the light source when seen at a distance. In some embodiments, the LEDs 228 are mounted on both the top and bottom sides such that in the event that one side of the PCB is covered, for example one side of the PCB is facing toward the luggage, then the other surface will be available to emit light. In one embodiment, the batteries 225 are mounted within cutout portions of the PCB in order to reduce the overall thickness. The case may be fabricated in top 223 and bottom 221 sections such that the thin layer of case material follows the surface of the PCB as closely as possible. An opening 227 may be provided in the case for a loop or strap to affix the tag to a luggage handle or to other objects. In some embodiments, an indentation in the top case 223 is provided to snap in an identification card 224 or a business card.

The top 223 or bottom 221 case parts may be fabricated from clear material and so shaped that a raised feature of the material 228 acts as a light pipe to distribute the light from the LEDs 226, causing a greater amount of light to be directed away from the emission axis of the LEDs 226. This results in a portion of the emitted light being directed toward the center of the device, while another portion of the light is directed away from the center of the device. The top and bottom halves may be fitted together so that they can be snapped in place. In other embodiments, the product is be finished with a compliant material stretched around the edge in the manner of a gasket. The gasket may provide a closure means of the case halves and provide a soft rugged “bumper” around the device.

The system in some embodiments includes at least one hub 202 having a radio frequency communication device configured to communicate with the at least one tag. FIG. 2E depicts one embodiment of at least one hub 202, which operationally connects the at least one tag 201a with additional devices. In some embodiments, the at least one hub 202 is a computing device 100 as described above in reference to FIG. 1. The at least one hub 202 in some embodiments connects via a radio interface to the cell phone data network 242. The at least one hub 202 may be coupled to a Wi-Fi data interface module 240, connecting the at least one hub 202 to a modem. The Wi-Fi data interface module 240 may connect the at least one hub 202 to a computing device. The Wi-Fi data interface module 240 may connect the at least one hub 202 to a computing device. The at least one hub 202 may be coupled to a Bluetooth transceiver 244, connecting the hub 202 to a modem. In some embodiments, the at least one hub 202 connects to additional devices via ZigBee®. In some embodiments, the hub 202 connects to a satellite network (not shown). In some embodiments, the at least one hub 202 connects to another device by wired means, such as Ethernet or USB. The at least one hub 202 in some embodiments is connected to a network, such as the Internet, by any means known in the art for connecting to a network. The at least one hub 202 is connected in some embodiments to a power supply 243, such as a “wall-wart” standard DC adapter.

In some embodiments, the at least one hub 202 and the at least one tag 201a combine to form a database, accessible to a user of an additional computing device connected to the at least one hub 201a. In some embodiments, each tag 201a contains data in its memory describing its state. Examples of state data include without limitation the good or goods to which the tag is assigned, the product number of the good or goods, the manufacture date of the good or goods, the lot number of the good or goods, the good or goods' current owner, the destination to which the good or goods are being shipped, if they are being shifted, any care instructions regarding the storage, shipment, or handling of the good or goods, and any information concerning the current state of the good or goods. Each tag 201a may also maintain in its memory structural data helping to coordinate the interaction of the tag with the at least one hub 202 or with its peer tags. Structural data, in an embodiment, is data organizing and optimizing the tag database, by sorting tags according to classes, subclasses, and indices as set forth in more detail below, or by establishing rules governing communication with the at least one hub 202 and with peers; for instance, and without limitation, the tag may contain structural data indicating its class and subclass membership as set forth in more detail below, its tag-specific message reception datum as set forth in more detail below, a right-of way transmission protocol, as set forth in more detail below, which duty cycle the tag should currently follow, which radio frequency the tag should currently use for communication, and what action the tag should take upon receiving input from one of its sensors 215. In some embodiments, each tag 201a is configured to respond to a query from a hub 202 with the data contained in its memory. In some embodiments, each hub 202 is configured to respond to a query from an additional computing device by querying all of the tags in communication with the hub 202 via radio-frequency signals, as described above, to receive the results of that query from each tag, and to relay the query results to the additional computing device. In some embodiments, a plurality of hubs 202 connects to one or more node devices (not shown). Each node device may be a computing device 101 as described above in reference to FIG. 1. Some embodiments of the system include a database accessible to the at least one hub 202. Some embodiments of the system include at least one computing device, transmitting data to the at least one hub and receiving data from the at least one hub 202.

FIG. 3 shows the use of the at least one hub 202 in one embodiment of the system 200. A hub 202 is able to communicate with a plurality of tags 201a using the wireless means previously described in reference to FIG. 2A. Such a plurality of tags 201a may have be grouped in one or more frequencies, for example four each of tags at frequency 1 304 and four each of frequency 2 303. When a remotely located application or database requires communication with a tag 201a, then such communication is accomplished via a connection 304 between that application or database 112 and the hub 202 as disclosed above in reference to FIG. 2E. The hub 202 acts as a “bridge” or switch, directing message traffic to and from the various tags 201a, and switching frequencies as needed to minimize power consumption.

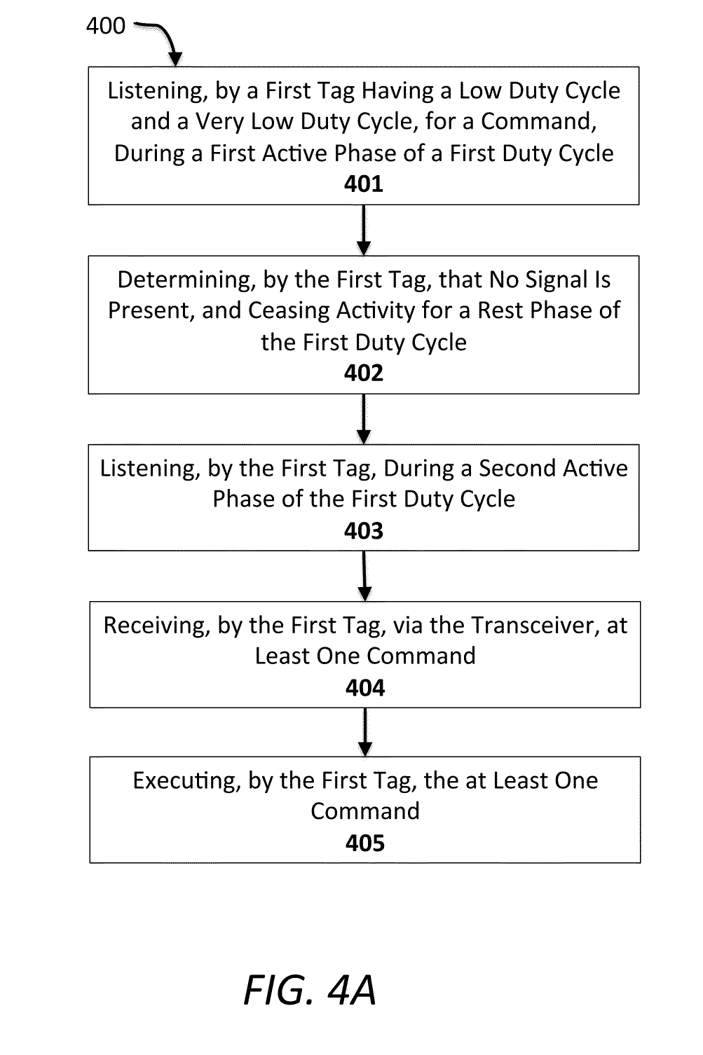

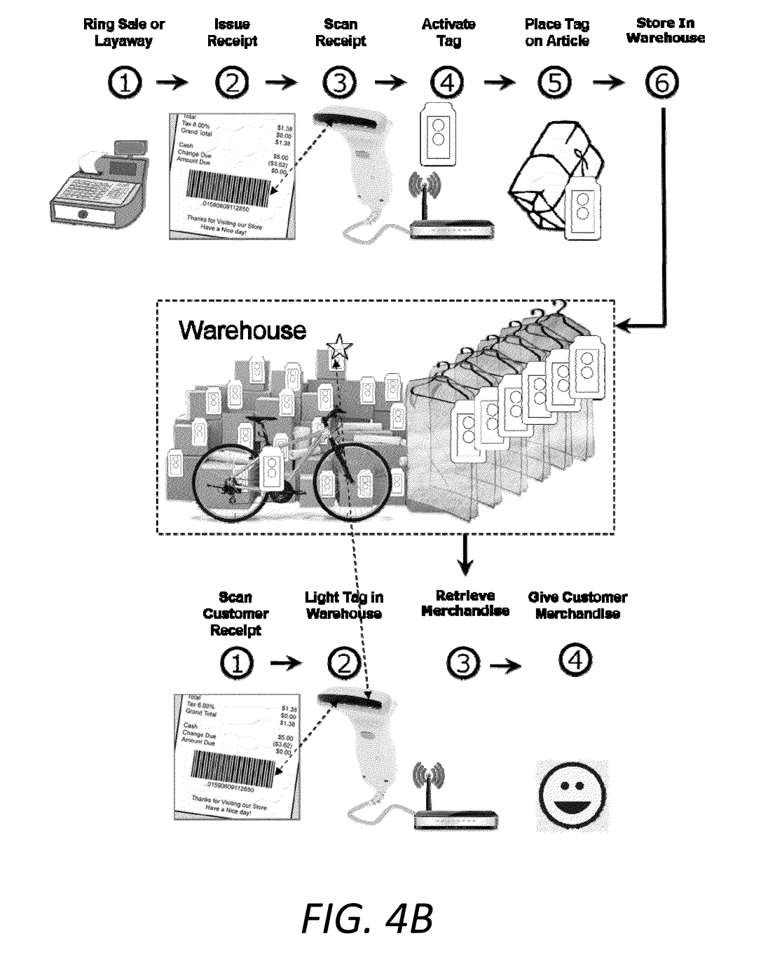

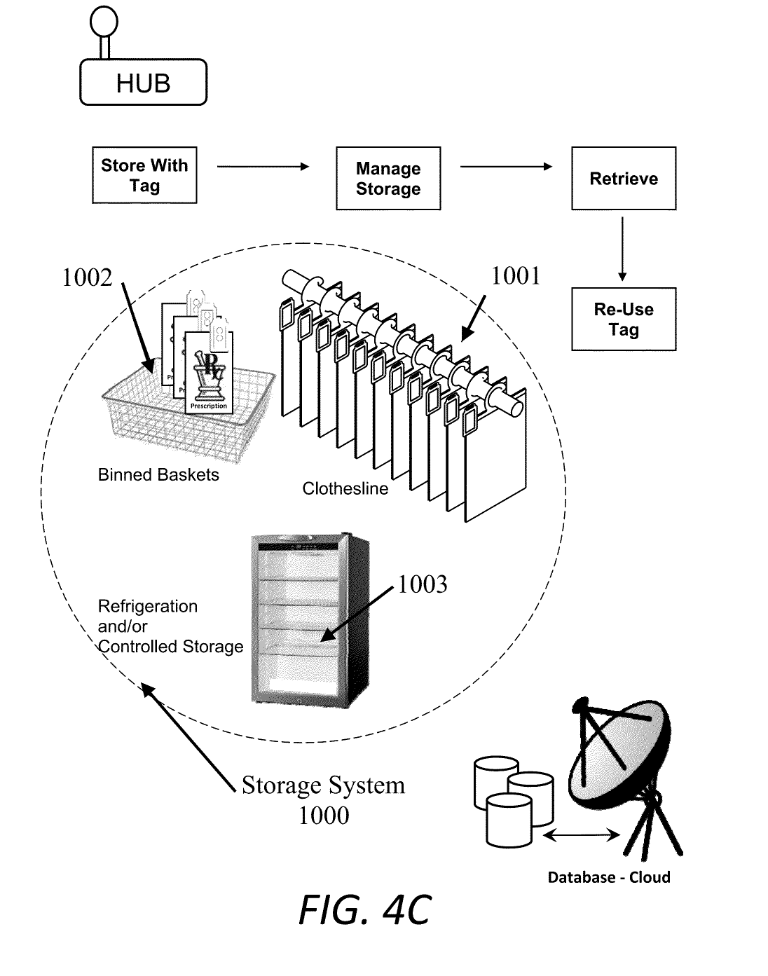

FIG. 4A illustrates some embodiments of the disclosed method 400. The method 100 includes listening, by a first tag as described above in reference to FIG. 2, for a command, during an active phase of a first duty cycle (401). In addition, the method 400 includes determining, by the first tag, that no command is present, and ceasing activity for a rest phase of the first duty cycle (402). The method 400 also includes listening, by the first tag, during a second active phase of the first duty cycle (403). The method 400 further includes receiving, by the first tag, via the transceiver, at least one command during the second active phase (404). The method 400 additionally includes executing, by the first tag, the at least one command (405).

Returning to FIG. 4A in further detail, and by reference to FIGS. 2A-3, the method 400 includes listening, by a first tag as described above in reference to FIG. 2, for a command, during an active phase of a first duty cycle (401). In some embodiments, the first duty cycle is the very low duty cycle, as defined above, in reference to FIG. 2B. In other embodiments, the first duty cycle is the low duty cycle, as defined above in reference to FIG. 2B. In some embodiments, listening is defined as listening on the radio frequency to which the first tag 201a is tuned for command, using the first tag's transceiver 213. In some embodiments, the microcontroller 211 of the first tag 201a is configured to detect whether a current is generated in the transceiver by a radio frequency signal to which the transceiver is tuned. In additional embodiments, the microcontroller 211 compares the signal to a pattern of data identifying signals pertaining to the first tag 201a. For instance, the first tag 201a may maintain in its memory 217 a code, such as a binary code, and an instruction causing the microcontroller 211 to ignore all signals except those using that code as a prefix. There may also be a postfix code maintained in the memory 217 of the first tag 201a, and an instruction directing the microcontroller 211 to ignore all signals that follow the postfix code. In some embodiments, the microcontroller 211 only interprets signals between a prefix code and a postfix code as signals, and ignores all other signals.

In addition, the method 400 includes determining, by the first tag, that no command is present, and ceasing activity for a rest phase of the first duty cycle (402). The determination that no command is present may involve determining that there is no radio traffic in the signal to which the first tag's transceiver 213 is tuned. The determination may also involve comparing the radio traffic the transceiver 213 receives to a datum stored in the memory of the first tag, as set forth above. Where the first duty cycle is a low duty cycle, the microcontroller may cease activity for 300 milliseconds. Where the first duty cycle is a very low duty cycle, the microcontroller may cease activity for 7 seconds.

The method 400 also includes listening, by the first tag, during a second active phase of the first duty cycle (403). The method 400 further includes receiving, by the first tag, via the transceiver, at least one command during the second active phase (404). In some embodiments, the first tag 201a receives the at least one command from a hub. In some embodiments, the first tag 201a receives the at least one command from a second tag 201b. The first tag 201a may compare the received data to data stored in memory 217 incorporated in the first tag 201a. In some embodiments, the hub 202 transmits a command to a plurality of tags simultaneously. Where there the tags' microcontrollers do not ignore signals lacking a tag-specific datum as described above, all tags in range will receive the signal from the hub 202. In some embodiments, where the tags ignore messages lacking tag-specific data, the hub 202 can still direct the command simultaneously to a plurality of tags; the hub 202 may, for instance, precede the command with a series of tag-specific codes corresponding to tags to which the hub 202 is directing its command. In an embodiment, the tags belonging to a particular group have a shared tag-specific datum; for instance, the hub 202 could address all tags pertaining to luggage belonging to a particular person because the tags all recognize the same identical prefix code. The hub 202 may transmit to any set of tags in range a tag-specific datum and a command directing them to process messages containing that datum thereafter, thus creating a new class of tags; for instance, the hub 202 may retrieve a list of tag-specific data corresponding to a set of tags it must address simultaneously, and send to each tag the same new tag-specific datum, so that each tag will recognize a message containing that datum. In some embodiments, the tags replace the tag-specific data with the shared datum. In some embodiments, the tags retain the tag-specific data; each tag in that case may recognize any message directed to its original tag-specific datum or to the new shared datum.

In some embodiments, the hub 202 also commands tags sharing a new datum to synchronize their active phases. Thus, the hub 202 may maintain in its memory the timing of each tag's duty cycle and may transmit a future command to the tags sharing the new shared datum only during the tags' now shared active phase, conserving energy and reducing radio traffic noise. For an interference-free receipt of messages from the tag class, the hub 202 may command each tag to transmit to the hub only when no other tag is transmitting. The hub 202 may command the tags to follow a particular schedule when replying, so that each tag responds only during its reserved time. Alternatively, the hub may provide each tag with a right-of-way protocol, such that the tag will delay transmission until a currently transmitting tag ceases transmission; the hub 202 may also require a buffer period after transmission ceases. In some embodiments, the right-of-way protocol includes a specific priority list, listing all tag-specific codes within the tag class and giving each a priority number; a tag with a lower priority number may be commanded to yield to a tag with a higher-priority number. Where the tag class contains all tags in range of the hub 202, the hub 202 may use the staggering or right-of-way protocol to distinguish between all of the tags' messages. Where the tags are capable of transmitting on more than one frequency, the hub 202 may also assign each tag in the class a different transmission frequency.

In some embodiments, the hub 202 may organize tags within a class into a subclass. The hub 202 may transmit to each tag a command instructing the tag to process signals containing the code of any class or subclass to which the tag belongs. In some embodiments, if tags in a particular class have synchronized active phases, then tags in a subclass will also have synchronized active phases as a result. The hub 202 may use any procedure described above for organizing classes to organize subclasses.

The method 400 additionally includes executing, by the first tag 201a, the at least one command (405). In some embodiments, a command is defined as any data that the first tag 201a receives that causes the first tag 201a to take any action, including without limitation instructions to execute a series of steps. When the first tag 201a receives a command it executes it. For instance, if the command is data to be stored, the first tag 201a may store the data in its memory 217. If the command is an instruction to execute a series of steps, the first tag 201a performs that series of steps. In some embodiments, executing the at least one command further comprises transmitting data using the transceiver. In an embodiment, transmitting further includes transmitting, to at least one additional tag 201b, a command. The first tag 201a may transmit to the at least one additional tag via a hub 202. The first tag 201a may transmit to the at least one additional tag using peer-to-peer communication: where the first tag 201a and the at least one additional tag 201b have transceivers tuned to the same frequency, and the at least one additional tag 201b is within the signal range of the first tag 201a, the first tag 201a may transmit a signal using its transceiver 213 which the second tag 201b can receive via its transceiver 213. Where the active phase of the at least one additional tag 201b does not occur at the same time as the active phase of the first tag 201a, the first tag 201a may transmit continuously until the at least one additional tag 201b receives the command, and signals to the first tag 201a to confirm receipt.

In some embodiments, the at least one additional tag 201b in turn sends a command to further tags. For instance, the first tag 201a may send a command to all tags in its transceiver range, and each of those tags may send a second command to all tags in its range; in some embodiments, the second command is the same as the first command, resulting in the first command spreading outward from the first tag 201a through the entire local population of tags. In some embodiments, the command is sent only to tags belonging to a particular group as described above regarding communication with a hub 202. An exemplary use of this approach occurs where a hub 202 fails. If there is a second hub 202 having at least one tag formerly pertaining to the failed hub 202 in its range, it can send a command to that tag, which can then cause the command to propagate through all of the other tags in the failed hub's range. The tags may also cause replying transmissions to propagate through all tags in turn, causing them to reach the overlapping hub 202. In this way, the tags may maintain connection with the system as a whole using peer-to-peer communication. In situations, such as a hub-failure scenario, where peer-to-peer signals are regularly needed, the tags may reset their duty cycles to minimize the time each tag must spend in active mode to contact the subsequent round of tags. For instance, during an initial peer-to-peer signal propagation, the initiating tag may send out a generation number, set to zero as an indication that it was the originator. All tags receiving the command thereafter may set increment their received generation number by one prior to transmitting the incremented generation number; the tags may thus determine the order in which they are likely to receive all subsequent signals, and each generation of tags may reset its duty cycle so that its active cycle partially overlaps with the active phase of the previous generation. This causes a wave of overlapping active phases to propagate through the tags, allowing each to verify whether a signal is being sent in either direction prior to returning to its rest phase.

An additional embodiment involves producing, by the at least one additional tag 201b, a signal using a signal-emitting facility coupled to the at least one additional tag. The at least one additional tag may, for instance, help a user locate the first tag 201a. As a non-limiting example, the additional tags may make out a path to the first tag from a warehouse door, which would work like airport indicator lights, flashing alternately in the direction of the first tag. Each additional tag may emit a very brief burst of light and still create the overall impression of a path. The tags surrounding the first tag 201a may flash in descending order of distance from the first tag, as indicated by signal strength. A person following the path may deactivate flashing tags along the way, for instance using each tag's touch sensor 215. In any case, all additional tags' signal patterns may switch off as soon as the person starts to interact with first tag having the primary status.

In a related embodiment, the at least one additional tag 201b duplicates, with its signaling facility 214 a signal being signaled by the first tag 201a as set forth in more detail below. For instance, a person may carry the at least one additional tag to the first tag 201a, have them exchange information to authenticate (as set forth in more detail below), transmit a command, or other matters; with this addition, the person could simply locate the first tag by searching for the one with the same LED flashing pattern. In other embodiments, the first tag 201a sends a command to one or more additional deployed tags 201b; for example, causing each to emit a signal with its signaling facility 214 so that the operator can find it. Thus, for instance, a set of tags pertaining to a particular category of items may all flash the same status; for example, all luggage belonging to a particular person could have tags that begin flashing as soon as the first piece of luggage is recovered, so that the person to whom the luggage belongs can find the remaining items rapidly.

In one embodiment, a hub 202 provides the transmitted data to a user. The hub 202 may provide the data via a display coupled to the hub, as described above in reference to FIG. 1. The hub 202 may provide the data via a network, such as the Internet, to a computing device used by the user. In an additional embodiment, a hub 202 stores the transmitted data in memory accessible to the hub 202. The memory may be the memory of the hub 202. The memory may be the memory of a local database. The memory may be the memory of a remote database. The memory may be the memory of a remote computing device. In some embodiments, the memory is the memory of a tag 201a.

In some embodiments, the hub 202 receives a query from a computing device, matches the query to the transmitted data, and provides the transmitted data to the computing device. In one embodiment, the hub 202 first receives the transmitted data, stores the transmitted data in its memory, and then compares the transmitted data to the query to determine whether the transmitted data matches the query. In another embodiment, the hub 202 receives the query first, and then interrogates the first tag 201a by sending it a command to transmit data, which the hub 202 compares to the query. In other embodiments, the hub 202 designs a command using the query, causing the first tag 201a to transmit only data matching the query. In some embodiments, the hub 202 compares the query to data transmitted by a plurality of tags, according to any of the methods just described.

In some embodiments, the hub 202 organizes the plurality of tags into tag classes, as described above, to optimize queries. As a non-limiting example, a user may have a user interface on the computing device that allows the user to organize tag data into tables by category, and to establish links between the tables using shared data fields, as in a relational database. The hub 202 may organize tags into classes that permit certain look-up actions to be performed more rapidly, based upon the relational database organization. In some embodiments, the user enters a command on the user's computing device explicitly directing the hub 202 to organize the tags into a particular set of tag classes. In some embodiments, the computing device derives a set of tag classes that optimize particular queries; for instance, where the user creates a table in the user interface, and establishes a particular column within that table as an “index” for that table the computing device may create tag classes grouped by shared data in the index column. A non-limiting example is a table that lists each tag's data by categories, and in which one category listed as an index category is a field (e.g., uniform product code) identifying the good to which the tag is appended; the computing device may send to each hub 202 a command directing the hub 202 to create a tag class for each set of tags with an identical good identification datum. Where there is more than one index field, the computing device may arrange the indices hierarchically, organizing data first according to a primary index, organizing data within that index by a secondary index, and so forth. The computing device may then direct each hub 202 to create subclasses of tags pertaining to each grouping according to higher-order indices. Thus, for instance, the primary index may be the identification of the tag's good, and the secondary index may be the manufacture date of the identified good. The hub 202 may organize the tags into classes according to the identification of their goods, and then further organize the tags in each class into subclasses according to their goods' manufacture dates.

In some embodiments, the user can enter queries in the computing device to retrieve tag data. In other embodiments, the computing device enters queries to retrieve tag data. In one embodiment, queries are entered using Structured Query Language (SQL). The computing device may relay the user-entered query to each hub 202. Each hub 202 may interrogate the tags using the query. Where a portion of the query seeks tags fitting a particular set of classes into which the hub 202 has already organized the tags, the hub may interrogate the tags in classes that match the query. In some embodiments, the hub organizes tags into additional classes or subclasses to optimize the query; for instance, if the query searches according to a field not currently used as an index, the hub 202 may organize the tags into a class or subclass matching that field, thus converting it into an index, and making subsequent refining queries more efficient. The computing device may pass an instruction to the hub 202 indicating that the query is being submitted by a periodically repeating process, and thus is a good candidate for optimization. The computing device may pass an instruction to the hub 202 indicating that the query is a high-volume query, and thus is a good candidate for optimization. Where the computing device discovers that the set of deployed tags presents an unbalanced data set according to current indexing, the computing device may direct the hub 202 to rebalance the data set by creating new indices, and assigning the tags new classes and subclasses. As a non-limiting example, where the initial index is based on organizing tags according to the product identification, and a large majority of tags are appended to products with identical identification, the index will not improve the efficiency of queries, and the primary index may be shifted to lot numbers, or manufacturing dates, to provide a more efficient way of dividing the tags into logical subsets.

In some embodiments, the hub 202 interrogates all tags and stores the data of all of the tags in a database accessible one or more hubs 202. The hub may thereafter update the database whenever a tag status changes, so that the database remains current. In one embodiment, queries from a user are primarily directed to the database. In another embodiment, queries from a computing device are primarily directed to the database. In other embodiments, queries from the user or computing device are directed primarily to the tags by the above-described methods. In some embodiments, the database is a duplicate of the data set contained in the tags, as organized by the hubs 202. In other embodiments, the database uses a key-value system to store previously run queries to the tag dataset for fast lookup. For instance, the computing device may periodically run a batch process retrieving the status of tags in particular classes, as disclosed above, and then save the result of each batch process in a key-value table so it may be rapidly retrieved. The computing device may convert the retrieved queries into reports.

The hub 202 may also direct tags to modify their memories as directed by the computing device. For instance, the user may enter an updated destination for a set of tags pertaining to a particular shipment of goods, and the hub 202 or hubs 202 in contact with that set of tags may update their state data to reflect the new destination. As another example, if the product pertaining to a particular tag stored in warehouse is sold, the hub 202 may send the tag a command causing it to record the new owner of the product in its memory. An additional example is where a particular lot of goods is recalled for health or safety reasons; the tags pertaining to all of the goods in that lot could be updated to maintain the recall information, including where they will be sent upon recall and what other actions should be taken regarding the recalled goods.

In some embodiments, the first tag 201a executes the at least one command by modifying the memory 217 of the first tag 201a. The first tag 201a may update data that is currently stored in its memory 217; for instance, the at least one command may contain a modification to the data stored in the memory 217 of the first tag 201a, such as an updated location or destination, or a new item to which the tag is attached. The first tag 201a may delete data. The first tag 201a may add new data to its memory 217. In some embodiments, executing the at least one command involves signaling, by a signal-emitting facility coupled to the first tag, a state of the first tag 201a. For example and without limitation, the first tag 201a may signal by flashing LEDs 214 coupled to the first tag, as provided above. The first tag 201a may emit an audio signal. The first tag 201a may emit a signal using a vibrator.

In some embodiments, executing the at least one command further involves switching to a second duty cycle. In one embodiment, the first duty cycle is the very low duty cycle, and the second duty cycle is the low duty cycle. In another embodiment, the first duty cycle is the low duty cycle, and the second duty cycle is the very low duty cycle. In an embodiment, switching to the second duty cycle involves the microcontroller 211 following the second duty cycle as described above for FIG. 2B; for instance, if the second duty cycle is the low duty cycle, the microcontroller 211 rests for the rest phase of a low duty cycle, and listens for commands during the active phase of a low duty cycle, as described above for steps (401)-(404). The microcontroller 211 may maintain the active and rest phase lengths of the current duty cycle in the memory 217 of the first tag 201a. The microcontroller 211 may maintain the active and rest phase lengths for each of the low duty cycle and the very low duty cycle in the memory 217. The microcontroller 211 may maintain in the memory 217 a datum indicating which of the two duty cycles it will currently follow. The command may explicitly instruct the first tag 201a to switch from one duty cycle to another. The command may present the first tag 201a with a scenario that matches a condition of a conditional command, stored in the memory of the first tag 201a, to switch from the first duty cycle to the second duty cycle.

The at least one command may direct the first tag 201a to switch duty cycles based upon circumstances of the current use of the first tag 201a. As described above, the low duty cycle permits the first tag to respond to queries received via its transceiver 213 with a reaction time acceptable for direct human interaction. Thus, the command may instruct a switch from the very low duty cycle to the low duty cycle under circumstances in which making the first tag available for querying by a person is desirable. Examples include but are not limited to when a shipping container comes near to a destination on its route, and persons at that destination need quickly to choose which merchandise to unload; when an emergency (such as a fire) requires an immediate inspection of the appropriate tag and its inventory; and times at which the persons in charge of the inventory in question need to perform a routine inspection of the inventory and tags. On the other hand, where circumstances favor power conservation and do not require immediate responses from the first tag 201a, the at least one command may direct the first tag 201a to switch to the very low duty cycle. For instance, if the tag is applied to merchandise shipping on a cargo ship, it may spend many days in the cargo hold without direct inspection; once the ship has embarked, the hub 202 may direct the first tag 201a to switch to the very low duty cycle to save energy during the long journey, as data concerning the state of the first tag 201a is very unlikely to change rapidly enough to warrant quicker exchanges of information. In some embodiments, the command further directs the first tag 201a to switch radio frequencies. For instance, the first tag 201a may use one radio frequency while in the very low duty cycle, and a second radio frequency while in the low duty cycle. In some embodiments, the command to switch radio frequencies is conditional; for example, the command may direct the first tag 201a to attempt a new frequency where interference on its current frequency prevents it from receiving a coherent message from the hub 202 or a second tag 201b.

In some embodiments, the first tag 201a receives an additional command from at least one sensor 215 coupled to the first tag 201a, and executes the additional command. The additional command may be any command as provided above. The sensor may be any sensor described above in reference to FIG. 2B. In some embodiments, the first tag 201a executes the additional command when the first tag 201a senses the additional command during the active phase of its duty cycle. In other embodiments, the first tag 201a immediately enters an active phase and executes the additional command; in other words, the first tag 201a responds immediately to input from the sensors. The latter approach permits immediate reaction to the kinds of events that have especial urgency, such as unexpected motion (possibly indicating theft), or unexpected temperature change (possibly indicating fire). In some embodiments, executing the at least one command involves maintaining, in the memory 217 of the first tag 201a, the at least one command, comparing, by the first tag 201a, the additional command to the at least one command, and executing, by the first tag, the at least one command responsively to the comparison with the additional command. Thus, for instance when a sensor 215 coupled to the first tag 201a sends the first tag 201a information, the first tag 201a may perform an earlier-received conditional command for which the sensor input is the condition. As an example, the first tag 201a may be programmed to respond to temperature input indicating a fire differently depending on its current circumstances; where a person nearby is likely to be available to help, the first tag 201a could signal using its signaling facility 214, whereas if nobody is likely to be nearby, the first tag 201a could instead transmit a signal to an automated fire control device using its transceiver 213. In some embodiments, the command causes the first tag 201a to switch from the very low duty cycle to the low duty cycle, placing it in a condition to communicate at speeds acceptable for a human operator. In still other embodiments, the additional command causes the first tag 201a to stop emitting a signal from its signaling facility; for instance, where the sensor 215 is a touch sensor, activation of the sensor 215 by a human operator might cause the first tag 201a to stop emitting the signal while the operator resolves the issue that gave rise to the signal, thus saving power. The activation of the touch sensor may also cause the first tag 201a and related tags to display in a coordinated fashion as described above.

In some embodiments, after the first tag executes the at least one command 405, it shuts down again for a rest phase. At that shut down, the first tag may rest for a full rest phase prior to its subsequent active phase. Alternatively, the first tag may rest until the next active phase it would have entered had the duty cycle not been interrupted by the at least one command. In some embodiments, where the first tag 201a has previously switched to the low duty cycle, the first tag 201a reverts to the very low duty cycle as a matter of default if a certain period elapses without activity.

FIG. 4B illustrates a method for using the disclosed system 200 to monitor layaway goods. Layaway operation is common at department stores. Traditionally, layaway goods are purchased by consumers in a preliminary purchase, or “layaway,” at reduced prices, and held throughout the calendar year, for pick-up at holiday time. Because the items may sit idle for months, without store personnel or purchaser interaction, the usual practice is to store the items by date of layaway and count on store employees to find the items as required. This approach to organizing the layaway goods is effective for finding the goods during the calendar year if they must be inspected for some purpose, but is inefficient during the critical holiday period when all customers are ready to claim their items nearly simultaneously.

FIG. 4B illustrates a method for organizing layaway goods. The method involves recording, on a computing device, the preliminary purchase. The method also involves providing, by the computing device, the recorded information to a tag as described above in reference to FIG. 2B. The method involves attaching, by a retailer, the tag to the good. The method further involves commanding, by the computing device, the tag to emit a signal using its signaling facility 214.

The method involves recording, on a computing device, the preliminary purchase. In some embodiments, the computing device is a payment-processing device; for example, the computing device may be the register at which the sale is processed. In some embodiments, the payment-processing device is operated by a retailer. In other embodiments, the payment-processing device is a self-checkout kiosk. The payment-processing device may be a web server; for instance, a customer may transact the preliminary purchase via the Internet, using a website affiliated with the seller. In some embodiments, the payment-processing device accepts the preliminary purchase via a local network. In some embodiments, the computing device is coupled to a payment-processing device. In other embodiments, the computing device records the preliminary purchase by scanning a receipt recording the preliminary purchase, using a scanner.

The method also involves providing, by the computing device, the recorded information to a tag as described above in reference to FIG. 2B. The computing device may transmit all of the recorded information to the tag 201a. The computing device may transmit a subset of the recorded information to the tag 201a; for instance, the computing device may send to the tag 201a sufficient information to identify the good, and no more. In some embodiments, the computing device is a hub 202. In other embodiments, the computing device is coupled to a hub 202. The hub 202 may transmit the recorded information to the tag via radio frequency communication as described above in reference to FIG. 4A. The hub 202 may transmit the recorded information to a peer tag, which transmits the recorded information to the tag 201a as described above in reference to FIG. 4A. In some embodiments, the tag 201a stores the recorded information in its memory 217.

The method involves attaching, by a retailer, the tag to the good. The method further involves commanding, by the computing device, the tag to emit a signal using its signaling facility 214. Commanding, in some embodiments, is performed as described above in reference to FIG. 4A. The system's extremely low power communication means makes possible the somewhat extended storage period with quick location when needed. In addition, during the storage period, the store has the ability to easily locate and query layaway items for other purposes not practical by existing methods, including telephone inquiry about the item, cancellation of layaway remotely, reminder to buyer pick up the good and collecting and removing recalled items.

FIG. 4C shows the system 200 deployed to manage prescriptions to be picked up at a pharmacy. For reasons of scale and practicality, many pharmacies solely manage the “regular” will call items such as pills, ointments, and syrups. Bulky items, refrigerated items, or controlled items are managed ad hoc or not at all. The minimal size and two-way messaging capability of the system logically integrates existing storage methods 420 including bins and baskets 421, clotheslines and racks 422, refrigerated and controlled items 423 thus allowing common management and retrieval of all stored items uniformly. Tags may be instructed to alert changes to the status of the drugs to personnel working in the pharmacy. As an example, refrigerated articles can self-report their condition on an event driven or recurring basis. Should an out-of-tolerance condition be signaled, such as an unacceptably high temperature, an attendant is messaged to intervene. Queries by family, or aging on-shelf, or recalled medications may be found within the pharmacy quickly. In the case of chain store operators, it would be straightforward to locate and remove recalled drugs across hundreds of pharmacies very quickly.

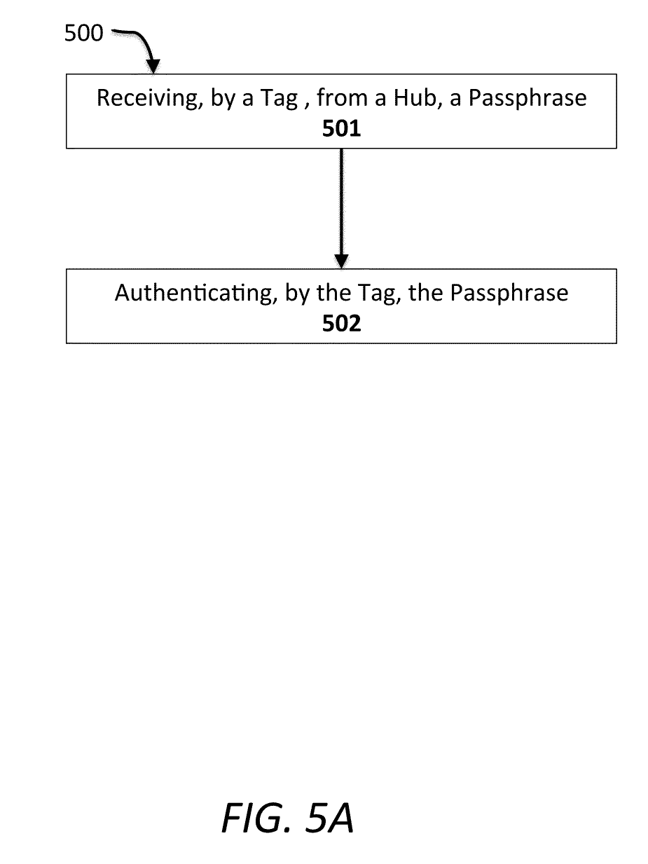

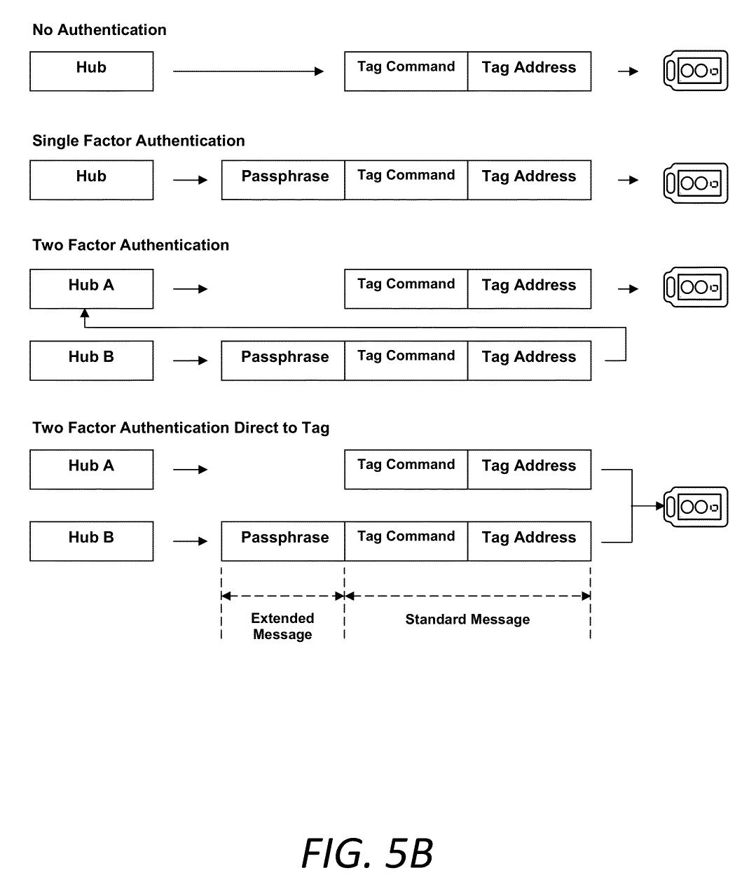

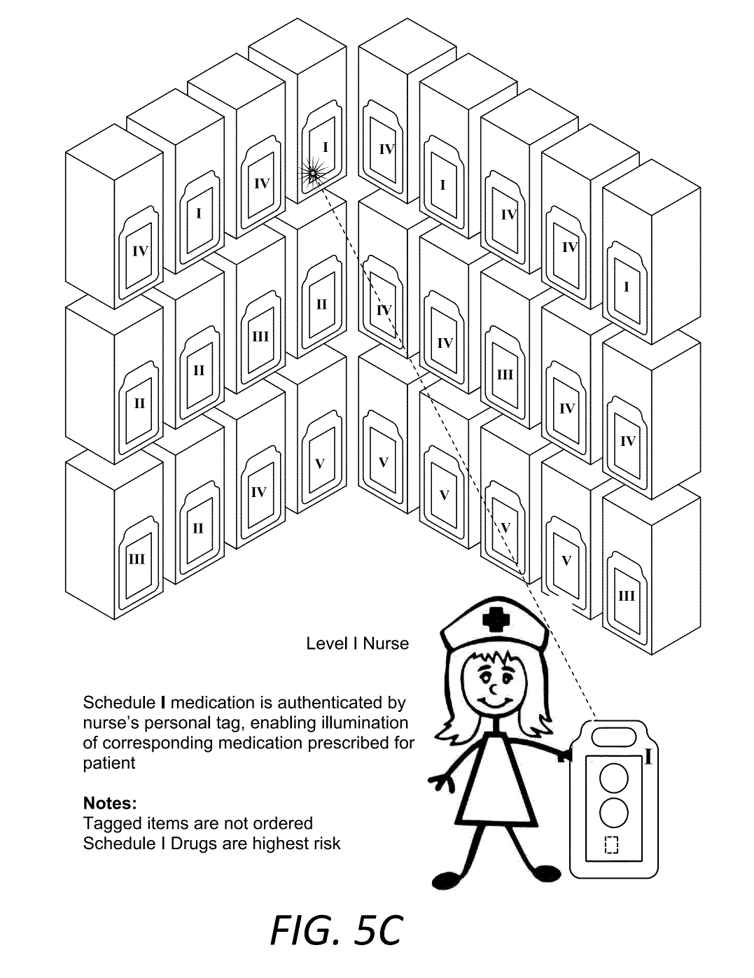

FIG. 5A illustrates some embodiments of a method 500 for authentication. The method 500 includes receiving, by a tag, from a hub, a passphrase (501). In addition, the method 500 includes authenticating, by the tag, the passphrase (502).

Returning to FIG. 5A in further detail, and by reference to FIGS. 2A-2E, the method 500 includes receiving, by a tag 201a, from a hub 202, a passphrase (501). In some embodiments, the tag 201a receives an encrypted passphrase and decrypts the encrypted passphrase. The tag 201a may use any encryption known in the art. The tag 201a may use private key encryption. The tag 201a may use public key encryption. In some embodiments, the tag 201a uses a combination of private key encryption and public key encryption. In some embodiments, the tag 201a uses a third-party cryptosystem. In some embodiments, in addition to the passphrase, the tag 201a receives, from a hub 202, a command. The tag may authenticate the passphrase, and only execute the command if the passphrase is valid. The command may be a command as described above in reference to FIG. 4A. In some embodiments, the tag receives the command from a peer tag. In particular, the tag could receive a first command via the hub, and require a second command affirming it to be received from a peer tag; for example, a peer tag carried by a person, as an identification badge or security access card. The peer tag may communicate with the tag 201a directly, as disclosed above in reference to FIG. 4A. In some embodiments, the success or failure of the operation can be optionally communicated back via the Peer Tag to enable two-factor confirmation of command status.

In addition, the method 500 includes authenticating, by the tag, the passphrase (502). In some embodiments, the microprocessor 211 of the tag 201a compares the passphrase to a passphrase stored in the memory 217 of the tag 201a. In some embodiments, the passphrase is installed in the tag memory 217 prior to the deployment of the tag 201a. In some embodiments, the hub 202 sends the tag 201a a command changing the passphrase. In some embodiments, the tag 201a changes the passphrase as instructed by the hub 202 only after first receiving a valid passphrase (501) and authenticating it (502). Some embodiments further involve receiving, from a second hub 202, a second passphrase, and authenticating, by the tag 201a, the second passphrase. In some embodiments, receiving the second passphrase also involves receiving an encrypted second passphrase and decrypting the encrypted second passphrase. In some embodiments, the tag 201a will perform some commands without authentication; for instance, the tag 201a may provide status to a hub 202 or peer tag 201a without requiring authentication, but may require authentication for any change to the data stored in the tag memory 217. In some embodiments, the passphrase 201a is entered on the tag via the hub at an earlier point. In some embodiments, the passphrase 201a is a one-time passphrase, generated by the tag in the same way that a passphrase is generated by a hard token. In some embodiments, one passphrase required by the tag is biometric, and is fed to the tag by a biometric reader accessible to the tag. FIG. 5B provides an alternate illustration of the various levels of authentication that the method described in FIG. 5A presents.

FIG. 5C shows an exemplary use of authentication to organize a controlled substance dispensary such as those common in hospitals, clinics and acute care facilities. In such a facility, it is desirable to segregate drugs, substances, and certain chemicals used to make drugs into five (5) distinct categories or schedules depending upon the drug's acceptable medical use and the drug's abuse or dependency potential. In this case a facility wishes to restrict the dispensing of controlled medications to authorized and properly trained personnel. Medications may be tagged using a tag as provided above in reference to FIG. 2B and mapped using a pre-defined danger level. For example highly addictive or dangerous medications may require the use of authentication requiring two passphrases, as disclosed above in reference to FIG. 5A, while simple antibiotics and analgesics could be dispensed without authentication. In some embodiments, each packet of medication has a tag. In some embodiments, the employer provides each dispensing employee with a personal tag coded to the level of medication dispensing authority. When the time comes to dispense a medication, the hub may direct the tag pertaining to the medication to be dispensed to signal with its signaling facility. The hub may also direct the tag to validating that the employee dispensing and administering the prescription had the credentials to do so, via peer-to-peer communication and authentication with the employee's personal tag, as provided above in reference to FIG. 5A

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A system for inventory monitoring and tracking, the system comprising:
at least one tag having a very low duty cycle, a low duty cycle, a transceiver, a memory, and a microprocessor configured to switch between the very low duty cycle and the low duty cycle, to transmit and receive signals via the transceiver, to read data from the memory, and to write data to the memory; and
at least one hub having a radio frequency communication device configured to communicate with the at least one tag.

2. A system according to claim 1, wherein the at least one tag is configured to communicate on a first radio frequency when operating in the very low duty cycle, and on a second, distinct radio frequency while operating in the low duty cycle.

3. A system according to claim 1, further comprising a database accessible to the at least one hub.

4. A system according to claim 1, further comprising a signaling facility coupled to the at least one tag.

5. A system according to claim 1, further comprising at least one sensor coupled to the at least one tag.

6. A system according to claim 5, wherein the at least one sensor further comprises a touch plate.

7. A system according to claim 5, wherein the at least one sensor further comprises a heat sensor.

8. A system according to claim 5, wherein the at least one sensor further comprises a motion sensor.

9. A system according to claim 1, further comprising at least one computing device, configured to transmit data to the at least one hub and to receive data from the at least one hub.

10. A method for inventory monitoring, the method comprising:
listening, by a first tag as provided in claim 1, for a command, during a first active phase of a first duty cycle;
determining, by the first tag, that no command is present, and ceasing activity for a rest phase of the first duty cycle;
listening, by the first tag, during a second active phase of the first duty cycle;
receiving, by the first tag, via the transceiver, at least one command during the second active phase; and
executing, by the first tag, the at least one command.

11. A method according to claim 10, wherein receiving the at least one command further comprises receiving the at least one command from a hub.

12. A method according to claim 10, wherein receiving the at least one command further comprises receiving the at least one command from a second tag.

13. A method according to claim 10, wherein executing the at least one command further comprises transmitting data using the transceiver.

14. A method according to claim 13, wherein transmitting further comprises transmitting, to at least one additional tag, a command.

15. A method according to claim 14, further comprising producing, by the at least one additional tag, a signal using a signal-emitting facility coupled to the at least one additional tag.

16. A method according to claim 13, further comprising providing, by a hub, the transmitted data to a user.

17. A method according to claim 13, further comprising storing, by the hub, the transmitted data in memory accessible to the hub.

18. A method according to claim 13, further comprising:
receiving, by a hub, a query from a computing device;
matching, by the hub, the query to the transmitted data; and
providing, by the hub, to the computing device, the transmitted data.

19. A method according to claim 10, wherein executing the at least one command further comprises modifying the memory of the first tag.

20. A method according to claim 10, wherein executing the at least one command further comprises signaling, by a signal-emitting facility coupled to the first tag, a state of the first tag.

21. A method according to claim 10, wherein executing the at least one command further comprises switching to a second duty cycle.

22. A method according to claim 10, wherein executing the at least one command further comprises switching radio frequencies.

23. A method according to claim 10, further comprising:
receiving an additional command from at least one sensor coupled to the tag; and
executing the additional command.

24. A method according to claim 23, wherein executing the at least one command comprises:
maintaining, in the memory of the first tag, the at least one command;
comparing, by the first tag, the additional command to the at least one command; and
executing, by the first tag, the at least one command based on the comparison with the additional command.

25. A method for authentication, the method comprising:
receiving, by a tag, from a hub, a passphrase; and
authenticating, by the tag, the passphrase.

26. A method according to claim 25, wherein receiving the passphrase further comprises:
receiving an encrypted passphrase; and
decrypting the encrypted passphrase.

27. A method according to claim 25, further comprising receiving, from the hub, a command.

28. A method according to claim 25, further comprising receiving, from a peer tag, a command.

29. A method according to claim 25 further comprising:
receiving, from a second hub, a second passphrase; and
authenticating, by the tag, the second passphrase.

30. A method according to claim 29, wherein receiving the second passphrase further comprises:
receiving an encrypted second passphrase; and
decrypting the encrypted second passphrase.
